(19) United States
(12) Patent Application Publication
(10) Pub. No.: US 2007/0163591 A1
(43) Pub. Date: Jul. 19, 2007

(54) METHOD AND SYSTEM FOR PROVIDING BREATHABLE AIR IN A CLOSED CIRCUIT

(76) Inventors: Julian T. Ross, McKinney, TX (US); Steve Dunford, Lewisville, TX (US)

Correspondence Address: CARR LLP, 670 FOUNDERS SQUARE, 900 JACKSON STREET, DALLAS, TX, 75202, US

(21) Appl. No.: 11/614,244

(22) Filed: Dec. 21, 2006

Related U.S. Application Data
(60) Provisional application No. 60/759,255, filed on Jan. 13, 2006.
(60) Provisional application No. 60/814,340, filed on Jun. 16, 2006.
(60) Provisional application No. 60/829,639, filed on Oct. 16, 2006.

(51) Int. Cl. A62B 7/08; A62B 21/00; A62B 7/10

(52) U.S. Cl. 128/205.12; 128/202.26

(57) ABSTRACT

The present invention provides for a closed circuit breathing unit comprising a reservoir bag, oxygen source, CO₂ scrubber, and actuation device. The oxygen source and an exit from the scrubber may be fluidly connected to the reservoir bag. The reservoir bag may be attached to a mouthpiece to provide inhalation air. Expired air may be exhaled through the mouthpiece and directed to an inlet for the scrubber. As a user breathes normally, expired air is scrubbed of excess CO₂, mixed with generated oxygen, and delivered to the user for inhalation within a closed circuit. Additionally, the oxygen source and the scrubber may be replaced and/or replenished without compromising or interrupting a breathing cycle.

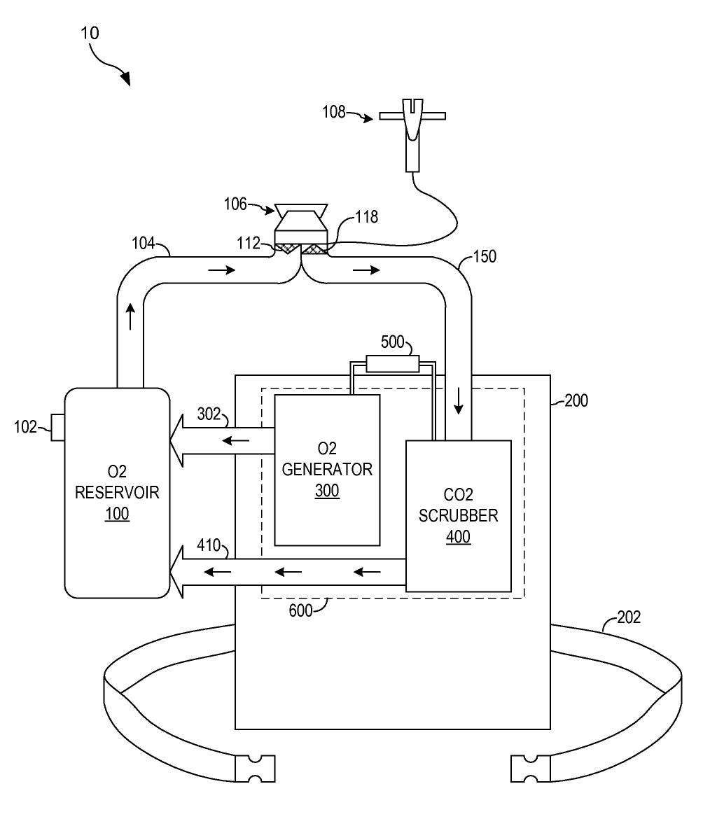

### CROSS-REFERENCED APPLICATIONS

This application relates to, and claims the benefit of the filing date of, co-pending U.S. Provisional Patent Application Ser. No. 60/759,255, entitled “METHOD AND APPARATUS FOR PROVIDING IMPROVED AVAILABILITY OF BREATHABLE AIR IN A CLOSED CIRCUIT”, filed Jan. 13, 2006, and of co-pending U.S. Provisional Patent Application Ser. No. 60/814,340, entitled “METHOD AND APPARATUS FOR PROVIDING IMPROVED AVAILABILITY OF BREATHABLE AIR IN A CLOSED CIRCUIT”, filed Jun. 16, 2006, and of U.S. Provisional Patent Application Ser. No. 60/829,639, entitled “DOCKABLE SYSTEM FOR PROVIDING IMPROVED AVAILABILITY OF BREATHABLE AIR IN A CLOSED CIRCUIT”, filed Oct. 16, 2006, the entire contents of which are incorporated herein by reference for all purposes.

### BACKGROUND OF THE INVENTION

1. Field of the Invention

The present invention relates to breathing devices and, more particularly, to closed circuit breathing devices.

2. Description of the Related Art

Self-rescuers have been used for a long time in mining, industrial and other hazardous environments or situations. Self-rescuers are used by workers, miners, and others in these types of perilous situations to provide a means to breathe or escape during the occurrence of hazardous, toxic, or otherwise dangerous conditions. Normal ambient air typically contains around 21% oxygen. However, expiratory air expelled from a person usually contains a lower percentage of oxygen, approximately 15% or less. This expiratory air can be re-breathed or reused provided it is sufficiently recycled and supplemented with the addition of oxygen. Recycling of expiratory air is accomplished by removing carbon dioxide (CO₂) from the expiratory air. This is the basic principle by which many self-rescuers function today. Expiratory air from the user of a self-rescuer is recycled by a CO₂ scrubber to produce scrubbed or recycled air that is added to the generated oxygen and then provided back to the user as breathable air. The cycle of inspiration, expiration, scrubbing, and oxygen supplementation continues in this fashion in a circuit closed to input from the external environment.

Since the user is breathing a relatively closed circuit of his/her own expired air, it follows that an initial supply of air may be needed in order to start the process cycle. In other words, the user needs to exhale or blow into the system so that the cycle can begin to generate breathable air. Alternatively, some of the current systems come with a starter in order to initiate the process of the self-rescuer. A starter is usually a small device able to produce an initial bolus of oxygen, typically around 6 liters. However, if the self-rescuer is incorrectly deployed by a user, the oxygen from this starter may be lost. This can represent a significant problem for the user as the user must then provide a tidal volume of air, which may have to be drawn from a potentially toxic environment.

Another challenge with some current systems is that an oxygen source is needed in order to supplement the air recycled from the user. Compressed tanks of oxygen cannot adequately perform this function since they represent an explosion hazard. Therefore they are unsafe to keep in sufficient quantities in underground mines and in other dangerous environments. Small compressed tanks may be used by rescue teams for their own systems, but as a general rule the small compressed tanks are not used with personal self-rescuers. The self-rescuers, usually referred to as Self-Contained Self-Rescuers (SCSRs), are the types of units used by miners or other personnel trapped or otherwise confronted with a hazardous environment. The SCSRs need to be person wearable (i.e., very portable). Consequently, the SCSRs would ideally be small and very light weight. This would make the use of a compressed oxygen tank in an SCSR generally infeasible. In addition to the need to provide a supplemental source of oxygen to initiate the process, a supplemental source of oxygen is also needed to extend the time period of generation of breathable air and to maintain the oxygen percentage in the available breathable air at or above the required safety levels. In many cases, these safety levels are mandated by government entities such as the National Institute of Occupational Safety and Health (NIOSH). For example, a minimum safety level of 19.5% oxygen for a particular rated duration may be a usable standard for some situations.

Another significant challenge with the current systems in use is that they are typically single use systems. If the system has exceeded a rated duration and the user requires more time, the user may gain more time (i.e., more breathable air) only by removing the entire expired system and thereafter “donning” an entirely new system. This donning procedure can take a significant amount of time and is typically performed while the user is under extreme duress, such as may be the case during an emergency escape from a hazardous situation. In addition, the user most likely has to hold their breath during the exchange due to the hazardous ambient environment. Failure to perform the procedure correctly and timeously (i.e., in a timely manner) or allowing panic to set in can be fatal to the user.

In some current systems the chemical reactions used to scrub CO₂ from the expired air, remove moisture, and/or generate the supplemental oxygen, are exothermic. The heat generated during these reactions may be applied directly to the recycled air. Subsequently, the temperature of the air inhaled by the user may increase with time, ultimately reaching uncomfortable or dangerous levels. The excess heat may be sufficiently high enough to cause burns on the user's lungs or tracheal areas, as well as burns in areas of contact with the unit assembly and breather tubes.

### SUMMARY OF THE INVENTION

An embodiment of the present invention provides a system that may deliver breathable air for use in hazardous environments. The system may comprise a housing that contains a oxygen generation source and a scrubber. An actuation device may be used to start generating oxygen and to access the scrubber. The scrubber may be attached to the breathing device to collect the exhalation of expired air by the user. The scrubber may remove excess CO₂ from the expired air and produce recycled air. The recycled air may be mixed in a reservoir bag with oxygen catalytically generated by the oxygen source. The mixture may be provided for inhalation by the user. The system closed to input from the external environment may provide the user with a relatively consistent and stable supply of breathable air.

### BRIEF DESCRIPTION OF THE DRAWING

For a more complete understanding of the present invention and the advantages thereof, reference is now made to the following Detailed Description taken in conjunction with the accompanying drawing, which is a schematic diagram illustration of a system of an embodiment of this invention.

### DETAILED DESCRIPTION

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the most part, details concerning well known features and elements have been omitted inasmuch as such details are not considered necessary to obtain a complete understanding of the present invention, and are considered to be within the understanding of persons of ordinary skill in the relevant art.

The entire contents of Provisional Patent Application Ser. No. 60/759,255, entitled “METHOD AND APPARATUS FOR PROVIDING IMPROVED AVAILABILITY OF BREATHABLE AIR IN A CLOSED CIRCUIT”, filed Jan. 13, 2006, and of co-pending U.S. Provisional Patent Application Ser. No. 60/814,340, entitled “METHOD AND APPARATUS FOR PROVIDING IMPROVED AVAILABILITY OF BREATHABLE AIR IN A CLOSED CIRCUIT”, filed Jun. 16, 2006, and of co-pending U.S. Provisional Application Ser. No. 60/829,639, entitled “DOCKABLE SYSTEM FOR PROVIDING IMPROVED AVAILABILITY OF BREATHABLE AIR IN A CLOSED CIRCUIT”, filed Oct. 16, 2006, are incorporated herein by reference for all purposes.

Turning now to the drawing, the reference numeral 10 generally indicates a breathing unit according to an embodiment of the present invention. This unit 10 may comprise a reservoir bag 100, a housing 200, a catalytic oxygen source 300, and a scrubber 400. In some embodiments, the reservoir bag 100 comprises a pressure relief valve 102 in addition to connections to various parts of the system. The reservoir bag 100 may be made of various materials without limitation, for example, a latex-free neoprene among others.

An illustrative embodiment of the system may comprise a re-usable housing 200 that accepts single-use, dockable cartridges 600 containing a catalytic non-compressed oxygen generation source 300 and a CO₂ scrubber 400. The reusable components of this embodiment may primarily comprise the outer housing 200 along with the actuation mechanism 500 and the cartridge seating system disposed within the housing 200. The disposable components of this embodiment may primarily comprise single use, disposable cartridges 600, or extension units. In this case, a single use refers to one single use for the rated duration of the cartridge 600 or extension unit. After that single use, the cartridge 600 may not be reused. There may be certain “single emergency” items, such as the inhalation tube 104, expiration tube 150, breathing apparatus such as the mouthpiece 106, and the reservoir bag 100. A single emergency may involve a number of single use cartridges 600 used by the same user over the course of one emergency (such as for example during an emergency egress from a mine). After the emergency, it may not be advisable to place the breather apparatus and reservoir bag 100 back into storage for further service, due to sanitary considerations.

The reservoir bag 100 may be fluidly connected to a mouthpiece 106 via an inhalation tube 104. Additionally, the reservoir bag 100 may be fluidly connected to the oxygen source 300 via an oxygen delivery tube 302. The reservoir bag 100 may also be fluidly connected to the scrubber 400 via a recycled air delivery tube 410. The various tubes may be made of materials such as polyethylene, polypropylene, rubber, or neoprene, among others. The various tubes may also be corrugated or reinforced for additional strength and durability. Some embodiments of the inhalation tube 104 may also comprise a one-way valve 112 to provide a substantially unidirectional flow in the inhalation tube 104.

An embodiment of the unit 10 may be configured such that the oxygen source 300 and the scrubber 400 are both housed within the same housing 200. The housing 200 itself may be made of a suitably durable and strong material in order to withstand a harsh environment typical for the intended use. The housing 200 may also be configured such that the oxygen source 300 and the scrubber 400 are both hot-swappable, meaning that they can be disconnected and removed from the housing 200 in a manner such as not to interrupt the flow of breathable air to the user. In a hot-swappable system, the user may continue to inhale from the reservoir bag 100 while the oxygen source 300 and the scrubber 400 are exchanged. Therefore, the housing 200 may be configured to accept replaceable sets of the oxygen source 300 and/or the scrubber 400. Consequently, the source of oxygen and the means to scrub the expired or exhaled air may be replaced or replenished without potentially interrupting the user's supply of breathable air. Additionally, the housing 200 may further be fitted with straps 202, clip (not shown), or some other means to conveniently attach the housing to a user. Thus, the unit 10 may be easily carried by the user.

An embodiment of the catalytic oxygen source 300 may generate oxygen by combining an appropriate oxidizing material with a catalyst in water. The water may also contain an additive to alter or modify the freezing point or the boiling point of water. The oxygen source 300 may generate oxygen on demand via a chemical reaction that occurs at temperatures considered to minimize any potential thermal hazards to the user. The oxygen source 300, including activation, management, and control methods and apparatuses are more fully described in the following patent applications. These patent applications are incorporated by reference herein as the “Ross Catalytic Oxygen Patent Applications.”
1. Ser. No. 10/718,131, entitled “Method & Apparatus for Generating Oxygen,” filed Nov. 20, 2003, (Docket No. ROSS 2864000)
2. Ser. No. 10/856,591, entitled “Apparatus and Delivery of Medically Pure Oxygen,” filed May 28, 2004, (Docket No. ROSS 2934000)
3. Ser. No. 10/045,805, entitled “Method and Apparatus for Controlled Production of a Gas,” filed Jan. 28, 2005, (Docket No. ROSS 3050000)
4. Ser. No. 11/158,993, entitled “Method and Apparatus for Controlled Production of a Gas,” filed Jun. 22, 2005, (Docket No. ROSS 3050001)
5. Ser. No. 11/159,016, entitled “Method and Apparatus for Controlled Production of a Gas,” filed Jun. 22, 2005, (Docket No. ROSS 3050002)
6. Ser. No. 11/158,377, entitled “Method and Apparatus for Controlled Production of a Gas,” filed Jun. 22, 2005, (Docket No. ROSS 3050003)
7. Ser. No. 11/158,362, entitled “Method and Apparatus for Controlled Production of a Gas,” filed Jun. 22, 2005, (Docket No. ROSS 3050004)
8. Ser. No. 11/158,618, entitled “Method and Apparatus for Controlled Production of a Gas,” filed Jun. 22, 2005, (Docket No. ROSS 3050005)
9. Ser. No. 11/158,989, entitled “Method and Apparatus for Controlled Production of a Gas,” filed Jun. 22, 2005, (Docket No. ROSS 3050006)
10. Ser. No. 11/158,696, entitled “Method and Apparatus for Controlled Production of a Gas,” filed Jun. 22, 2005, (Docket No. ROSS 3050007)
11. Ser. No. 11/158,648, entitled “Method and Apparatus for Controlled Production of a Gas,” filed Jun. 22, 2005, (Docket No. ROSS 3050008)
12. Ser. No. 11/159,079, entitled “Method and Apparatus for Controlled Production of a Gas,” filed Jun. 22, 2005, (Docket No. ROSS 3050009)
13. Ser. No. 11/158,763, entitled “Method and Apparatus for Controlled Production of a Gas,” filed Jun. 22, 2005, (Docket No. ROSS 3050010)
14. Ser. No. 11/158,865, entitled “Method and Apparatus for Controlled Production of a Gas,” filed Jun. 22, 2005, (Docket No. ROSS 3050011)
15. Ser. No. 11/158,958, entitled “Method and Apparatus for Controlled Production of a Gas,” filed Jun. 22, 2005, (Docket No. ROSS 3050012)
16. Ser. No. 11/158,867, entitled “Method and Apparatus for Controlled Production of a Gas,” filed Jun. 22, 2005, (Docket No. ROSS 3050013)
17. Ser. No. 60/699,094, entitled “Method and Apparatus for Generating Oxygen,” filed Jul. 14, 2005, (Docket No. ROSS 2864002)
18. Ser. No. 60/742,436, entitled “Flexible Reaction Chamber with Frangible Seals and Activation Methods,” filed Dec. 5, 2005, (Docket No. ROSS 3367000)
19. Ser. No. 60/736,786, entitled “Method and Apparatus for Delivering Oxygenated Heated Vapor in Skin Care Applications,” filed Nov. 15, 2005, (Docket No. ROSS 3361000)
20. Ser. No. 60/735,011, entitled “Oxygen Patch,” filed Nov. 15, 2005, (Docket No. ROSS 3353000)

Excess CO₂ in the expiratory air may be removed by the scrubber 400. The scrubber 400 in some embodiments may comprise soda-ash/soda-sorb or potassium superoxide (KO₂), for example, as an active ingredient to remove the CO₂. In addition, the scrubber 400 may comprise calcium oxide (CaO) to remove other gasses, such as but not limited to, sulfur dioxide and hydrogen sulfide. The scrubber 400 may be fluidly connected to the mouthpiece 106 via an exhalation tube 150. The exhalation tube 150 may further comprise a one-way valve 118 to provide a substantially unidirectional flow of expired air from a user. Scrubbed or recycled air exits the scrubber 400 and may be directed to the reservoir bag 100 via a recycled air delivery tube 410.

An embodiment of the unit 10 may comprise a mouthpiece 106. The mouthpiece 106 may be connected to the reservoir bag 100 via an inhalation tube 104. Additionally, the mouthpiece 106 may be connected to the scrubber 400 via an exhalation tube 150. Certain embodiments of the unit 10 comprise one-way valves 112 and 118 respectively operationally connected to the inhalation tube 104 and the exhalation tube 150. The one-way valves 112 and 118 may be respectively located at the proximal ends of each of the tubes 104 and 150. These one-way valves 112 and 118, provide for a substantially unidirectional flow in each of the tubes 104 and 150, and thereby create a circuit for a breathing cycle. An embodiment of the mouthpiece 106 may comprise the one-way valves 112 and 118, incorporated into a wye-connector. The unit 10 may further comprise a nasal passageway obstructer or blocking device, such as a nose-clip 108, to ensure that the primary mechanisms of inhalation and exhalation are directed through the mouth of a user. Other embodiments of the unit 10 may comprise a face-mask (not shown) in place of the mouthpiece 106 and/or nose-clip 108.

An actuation device 500 may be located on the top of the housing 200 of a unit 10. The actuation device 500, such as a knob or lever, may allow the user to create passageways into the scrubber 400 and/or oxygen source 300, in addition to enabling the combining together of previously separated chemicals, in order to commence the operation of the breathing unit 10. As a result, the breathing unit 10 may be placed in a relatively inert condition for storage, and still be simply activated by the user. A simple activation process may be configured to enable a wide range of consumers to use the system in a medical or other applicable emergency. A simple activation process may also minimize the potential for improper use or mistake by users who may already be under tremendous amounts of psychological and physical stress as a result of an emergency situation. Other examples of actuation devices 500 and methods may be found in the Ross Catalytic Oxygen Patent Applications previously listed and incorporated herein by reference.

An embodiment of a closed-circuit breathing unit 10 may function as follows. A user, having been alerted to a hazardous condition or environment, may attach the housing 200 of a unit 10 to his/her person using straps 202, clips, or some other convenient attachment device. The oxygen source 300 may then be started through the use of an actuation device 500 in order to begin the catalytic production of oxygen gas. The oxygen gas may flow out from the oxygen source 300 and enter the reservoir bag 100 via the oxygen delivery tube 302. In certain embodiments, the user may then insert the mouthpiece 106 into his/her mouth and attach the nose-clip 108. As the user continues to breath normally, oxygen may flow from the reservoir bag 100 via the inhalation tube 104, into the mouthpiece 106. The unit 10 may be self-initiating, meaning that the user does not have to provide a first tidal volume of air to commence the operation of the unit 10. From the point of actuation, the oxygen source 300 may commence filling the reservoir bag 100 with oxygen. The user may then be able to breathe oxygen from the reservoir bag 100, prior to the system processing recycled expired air.

Expired air may then flow from the user via the mouthpiece 106 and the exhalation tube 150 into the scrubber 400. The expired air may be chemically scrubbed of excess CO₂ and exit from the scrubber 400. The recycled expired air may then continue to flow into the reservoir bag 100 via the recycled air delivery tube 410. The recycled expired air may mix with the generated oxygen from the oxygen source 300, resulting in breathable air. The breathable air flows to the user through the inhalation tube 104, completing a circuit. Consequently, the closed-circuit for an illustrative embodiment may comprise the mouthpiece 106, connected by the expiration tube 150 to the scrubber 400, the scrubber 400 connected to the reservoir bag 100 by the recycled air delivery tube 410, and the reservoir bag 100 connected to the mouthpiece 106 by the inhalation tube 104. Within this closed-circuit, oxygen is being added to the reservoir bag 100 though the oxygen delivery tube 302 from the oxygen source 300. The user may continue to breathe a mixture of oxygen and recycled air as the unit 10 continues to cycle through the circuit.

After a certain time duration, one or both of the oxygen source 300 and the scrubber 400 may need to be replaced or replenished. An embodiment of the unit 10 may enable a user to hot-swap one or both of these elements. By hot-swapping, a user may be able to replace or replenish the elements without compromising the quality of air in the system or without having to interrupt a current breathing cycle. Sealed cartridges 600 containing the oxygen source 300 and/or the scrubber 400 may be designed to dock with the housing assembly 200 via normally closed valves (not shown). The valves on the reservoir bag 100 and the cartridge 600 may be opened only as a new cartridge 600 is locked in place. This action prevents the inclusion of the ambient atmosphere into the circuit of the breathing unit 10 during the cartridge swap. In addition, another valve may close off the distal end of the expiration tube 150 in order to prevent ambient air from entering into the disconnected tube 150. In other words, valves may be located at either end of all connection points to a cartridge 600. During the swap, the user may be able to continue drawing breathable air from the reservoir bag 100. Repeated replacement and/or replenishment of the oxygen source 300 and the scrubber 400 may allow a user to continuously use the breathing unit 10 for an indefinite period of time.

Having thus described the present invention by reference to certain exemplary embodiments, it is noted that the embodiments disclosed are illustrative rather than limiting in nature. A wide range of variations, modifications, changes, and substitutions are contemplated in the foregoing disclosure. In some instances, some features of an embodiment of the present invention may be employed without a corresponding use of the other features. Many such variations and modifications may be considered desirable by those skilled in the art based upon a review of the foregoing description of the illustrative embodiments. Accordingly, it is appropriate that the appended claims be construed broadly and in a manner consistent with the scope of the invention.

We claim:

1. A system for producing vital air, the system comprises:
a reservoir;
an oxygen source configured to catalytically produce a gas that comprises oxygen;
a scrubber configured to remove CO₂ from a gas, producing recycled air;
a breathing interface configured to accept expired air from a user and to provide the vital air to the user;
an actuation device;
wherein the actuation device is operated to commence production of the oxygen;
wherein the oxygen source provides oxygen to the reservoir;
wherein the scrubber receives the expired air from the breathing interface and provides the recycled air to the reservoir; and
wherein the breathing interface receives the vital air from the reservoir.

2. The system of claim 1 wherein the breathing interface comprises:
a mouthpiece;
a first one-way valve;
a second one-way valve;
a nasal passageway obstructer;
wherein the mouthpiece is connected to the reservoir via the first one-way valve;
wherein the mouthpiece is connected to the scrubber via the second one-way valve; and
wherein the first and the second one-way valves provide a substantially unidirectional flow through the system.

3. The system of claim 1 wherein the breathing interface comprises:
a face mask;
a first one-way valve;
a second one-way valve;
wherein the facemask is connected to the reservoir via the first one-way valve;
wherein the facemask is connected to the scrubber via the second one-way valve; and
wherein the first and second one-way valves provide a substantially unidirectional flow through the system.

4. The system of claim 3 wherein the breathing interface further comprises a nasal passageway blocking device.

5. The system of claim 1 wherein the system further comprises:
a housing attachable to the user;
wherein the oxygen source and the scrubber are located within the housing; and
wherein the at least one of the group consisting of the oxygen source and the scrubber are replaceable.

6. The system of claim 5 wherein the housing further comprises a releasably engagable strap to attach the housing to the user.

7. A system for producing life-sustaining air, the system comprises:
a reservoir;
an oxygen source configured to catalytically produce a gas that comprises oxygen;
a scrubber configured to remove CO₂ from a gas, producing recycled air;
a housing configured to removably contain the oxygen source and the scrubber;
a breathing interface configured to accept expired air from a user and to provide inhalation air to the user;
an actuation device;
wherein operation of the actuation device commences production of the oxygen;
wherein the oxygen source provides oxygen to the reservoir;
wherein the scrubber receives the expired air from the breathing interface and provides the recycled air to the reservoir;
wherein the inhalation air is produced from combining the recycled air and the oxygen within the reservoir; and
wherein the reservoir provides the inhalation air to the breathing interface.

8. The system of claim 7 wherein the breathing interface comprises:
a mouthpiece;
a first one-way valve;
a second one-way valve;
a nasal passageway blocking device;
wherein the mouthpiece is connected to the reservoir via the first one-way valve;
wherein the mouthpiece is connected to the scrubber via the second one-way valve; and
wherein the first and the second one-way valves provide a substantially unidirectional flow through the system.

9. The system of claim 7 wherein the housing further comprises a releasably engagable strap to attach the housing to the user.

10. The system of claim 7 wherein the breathing interface comprises:
a face mask;
a first one-way valve;
a second one-way valve;
wherein the facemask is connected to the reservoir via the first one-way valve;
wherein the facemask is connected to the scrubber via the second one-way valve; and
wherein the first and the second one-way valves ensure a unidirectional flow through the system.

11. The system of claim 10 wherein the housing further comprises a releasably engagable strap to attach the housing to the user.

12. An apparatus for producing vital air, the apparatus comprises:
an oxygen source configured to catalytically produce a gas that comprises oxygen;
a scrubber configured to remove CO₂ from a gas, producing recycled air;
an actuation device configured to initiate production of the oxygen; and
a housing configured to removably contain the oxygen source and the scrubber.

13. The apparatus of claim 12 wherein the housing is releasably attachable to a user.

14. The apparatus of claim 13 wherein the housing further comprises a releasably engagable strap to attach the housing to the user.

15. The apparatus of claim 12 wherein the scrubber further comprises one of the group consisting of soda ash, soda-sorb, and potassium superoxide.

16. The apparatus of claim 12 wherein the oxygen source further comprises:
an oxidizing material;
a catalyst; and
water.

17. An apparatus for producing life-sustaining air, the apparatus comprises:
an oxygen source configured to produce a gas that comprises oxygen;
wherein the oxygen source comprises:
an oxidizing material;
a catalyst;
water; and
an additive to alter a phase-transition point of the water;
a scrubber configured to remove CO₂ from expired air, producing recycled air;
a housing configured to removably contain the oxygen source and the scrubber;
an actuation device configured to commence production of the oxygen;
wherein the expired air is provided to the scrubber; and
wherein the recycled air and the oxygen are provided to an apparatus user.

18. The apparatus of claim 17, wherein the scrubber further comprises potassium superoxide.

19. The apparatus of claim 17, wherein the scrubber further comprises soda ash.

20. The apparatus of claim 17, wherein the scrubber further comprises calcium oxide.

21. The apparatus of claim 17, wherein the housing is attachable to the apparatus user.

22. The apparatus of claim 21, wherein the housing further comprises a releasably engagable strap.

23. A method for using a rebreather system, in which the method comprises:
placing a first rebreather cartridge within a housing;
coupling an oxygen source and a scrubber of the first rebreather cartridge to a breathing reservoir;
coupling a mouthpiece to the breathing reservoir and the scrubber of the first rebreather cartridge;
commencing oxygen generation by the oxygen source of the first rebreather cartridge via an actuation device;
placing the mouthpiece on a breathing passageway of a user;
exhaling expired air into the mouthpiece;
removing excess CO₂ from the expired air using the scrubber of the first rebreather cartridge, producing recycled air;
mixing the recycled air and the generated oxygen within the breathing reservoir;
inhaling the mixture of the recycled air and the generated oxygen via the mouthpiece; and
replacing the first rebreather cartridge with a second rebreather cartridge.

24. The method of claim 23 in which the step of replacing the first rebreather cartridge further comprises:
decoupling the mouthpiece from the scrubber of the first rebreather cartridge;
decoupling the oxygen source and the scrubber of the first rebreather cartridge from the breathing reservoir;
removing the first rebreather cartridge from the housing;
placing the second rebreather cartridge in the housing;
coupling an oxygen source and a scrubber of the second rebreather cartridge to the breathing reservoir;
coupling the mouthpiece to the scrubber of the second rebreather cartridge; and
commencing oxygen generation of the oxygen source of the second rebreather cartridge via the actuation device.

25. A method for producing vital air, the method comprises:
initiating generation of oxygen from an oxygen source via an actuation device;
exhaling into a scrubber configured to remove CO2 from expired air, the scrubber producing recycled air;
mixing the oxygen and the recycled air in a reservoir; and
inhaling the mixture of oxygen and recycled air from the reservoir via a breathing apparatus.
